(19) United States
(12) Patent Application Publication
(10) Pub. No.: US 2006/0100841 A1
(43) Pub. Date: May 11, 2006

(54) Automatic system and method for testing mobile phone

(76) Inventors: Tung-Ho Wu, Hsin Chu City (TW); Kant Chiou, Chang Hua Hsien (TW)

Correspondence Address: BIRCH STEWART KOLASCH & BIRCH, PO BOX 747, FALLS CHURCH, VA, 22040-0747, US

(21) Appl. No.: 10/932,085

(22) Filed: Sep. 2, 2004

(51) Int. Cl. G06F 9/44

(52) U.S. Cl. 703/20

(57) ABSTRACT

An automatic testing system and method are used for testing a mobile phone instead of a manual test operation. The automatic testing system uses a base station simulator and a test computer. The computer converts an operational message from the base station simulator into a test command. In the method according to the present invention, an automatic test program finds a test command corresponding to the operational message from a lookup table. The test command is then sent to the mobile phone under test and then the base station simulator validates a performance of the mobile phone by examining an execution result of the mobile phone. Test time is reduced and test correctness is enhanced for a mobile phone.

### BACKGROUND OF THE INVENTION

1. Field of the Invention

The present invention relates to an automatic testing system and method for testing a mobile phone, and more particularly to an automatic testing system and method for testing a mobile phone through using a computer.

2. Description of Prior Art

Mobile phones are becoming increasingly popular, and new models having enhanced functions are needed by consumers. To ensure whether functions of a mobile phone are normal or not, the mobile phone requires a series of tests before being shipped to distributors. Moreover, in a laboratory, a mobile phone is often subjected to a functional test which is achieved by R&D engineers for validating the performance thereof.

The test for a mobile phone can be performed by a testing instrument, which, for example, can be Anite testing instrument of Anite Telecom Company or CRTC testing instrument of RHODE&SCHWARS (R&S) Company. The testing instrument generally tests the mobile phone by providing a signal, which simulates a signal from a base station.

The testing instrument will show various operator messages first, and the testing engineer follows the operator messages to operate the mobile phone under test. For example, when the operator message indicates turning on power of the mobile phone, the testing engineer will manually press the power button of the mobile phone to turn on the mobile phone. Moreover, when the operator message indicates inputting data, such as inputting a dialed phone number, the testing engineer will manually operate the keypad of the mobile to input a phone number. The testing instrument detects the wireless signal emitted from the mobile phone to validate the operation of the mobile phone under test; however, through the above-mentioned testing procedures, it can be known whether the functions of the mobile phone are normal or not.

However, in the above-mentioned testing procedures, because operation of the mobile phone and judgment of operator messages are achieved by human being, the testing procedures of the mobile phone are time-consuming, and could go wrong easily.

### SUMMARY OF THE INVENTION

It is the object of the present invention to provide an automatic testing system and method for testing mobile phone through using a computer, whereby the test time is saved, and test reliability is enhanced.

To achieve the above object, the present invention provides an automatic testing system for a mobile phone. The automatic testing system comprises a base station simulator providing at least one operational message, and a test computer connected to the base station simulator through a transmission port, and converting the operational message into a test command for outputting to a mobile phone under test. Upon receipt of the test command, the mobile phone automatically will execute the test command, and the base station simulator validates a performance of the mobile phone by examining an execution result of the mobile phone.

To achieve the above object, the present invention provides an automatic testing method for a mobile phone. The automatic testing method comprises the steps of: providing a test computer to test a mobile phone under test; the test computer converting an operational message from a base station simulator into a test command; the test computer sending the test command to the mobile phone; and the base station simulator validating an execution result of the mobile phone.

The above summaries are intended to illustrate exemplary embodiments of the invention, which will be best understood in conjunction with the detailed description to follow, and are not intended to limit the scope of the appended claims.

### BRIEF DESCRIPTION OF THE DRAWINGS

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows the block diagram of the automatic testing system according to the present invention;

FIG. 2 shows a flowchart for the operation of the automatic testing system according to the present invention;

FIG. 3 shows a flowchart for the lookup table operation of the automatic testing system according to the present invention; and

FIG. 4 shows the lookup table according to the present invention.

### DETAILED DESCRIPTION OF THE INVENTION

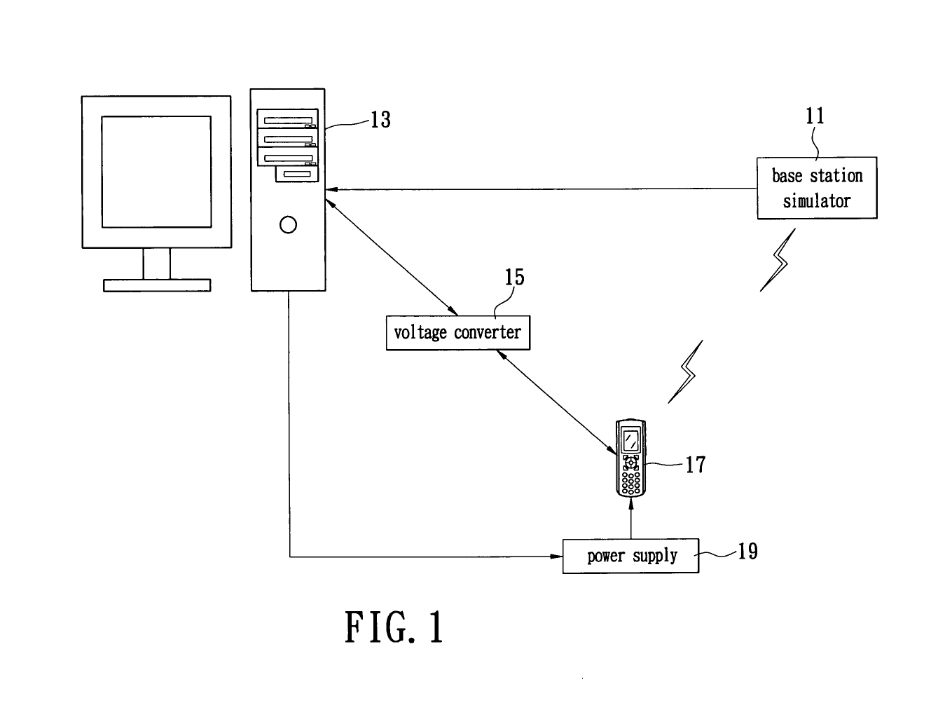

FIG. 1 shows the block diagram of the automatic testing system according to the present invention, which comprises a base station simulator 11, a test computer 13, a voltage converter 15 and tested mobile phone 17 and a power supply 19.

The base station simulator 11 provides an operational message for manifesting the testing items for the mobile phone 17. The base station simulator 11 further validates the testing result to ensure normal operation of the mobile phone 17. More particularly, the base station simulator 11 receives a wireless signal from the mobile phone 17 to validate the testing result and to ensure normal operation of the mobile phone 17. In the preferred embodiment of the present invention, the base station simulator 11 is preferably the Anite testing instrument of the Anite Telecom Company or the CRTC testing instrument of the R&S Company. The above-mentioned testing instruments can provide standard test cases for different types of mobile phones such as GSM mobile phones or GPRS mobile phones.

In the preferred embodiment of the present invention, the computer 13 converts the operational message of the base station simulator 11 into a test command and sends the test command to the mobile phone 17 for command execution. The step of converting the operational message of the base station simulator 11 into the test command is performed by an automatic test program in the computer 13. The automatic test program in the computer 13 first reads the operational message and then finds the corresponding test command from a lookup table, which provides a link between the operational message and the corresponding test command. In the preferred embodiment of the present invention, the test command is sent to the mobile phone 17 in the form of an AT command and the test command includes data transmission command such as dialing and power control commands. In other word, in present invention, the manual operation is replaced by automatic operation executed by computer.

The operational message of the base station simulator 11 is sent to the computer 13 through a connection wire connected to a transmission port of the computer 13. For example, the transmission port of the computer 13 can be an RS-232 port and the automatic test program receives the operational message of the base station simulator 11 from the RS-232 port.

The test command converted by the automatic test program is sent to the mobile phone 17 through a transmission port of the computer 13. The voltage converter 15 is connected between the computer 13 and the mobile phone 17 and converts a voltage from the computer 13 into a voltage level acceptable for the mobile phone 17.

The voltage from the RS-232 port has a level of ±12V, which is excessive for the mobile phone 17. The voltage converter 15 converts a voltage from the RS-232 port into a voltage level such as 3V, which is acceptable for the mobile phone 17. It should be noted the voltage converter 15 could be eliminated if the voltage supplied from the computer 13 has a level acceptable for the mobile phone 17. For example, if the transmission port of the computer 13 is a USB port, this port can output voltage of a suitable level for the mobile phone 17.

As to the operation of automatic turning on of the mobile phone 17, the operations for turning on the mobile phone and for supplying power to mobile phone are provided. When the impulse signal identifies the operational message indicating the turning on of the mobile phone 17, the computer 13 outputs a test command indicating the turning on of the mobile phone 17. The test command asks the voltage converter 15 to produces a signal simulating the turning on operation such as an impulse signal achieved by connecting an output pin of the voltage converter 15 to the power switch of the mobile phone 17. Therefore, the mobile phone 17 can be turned on by the impulse signal and then the impulse signal controls the power supply 19 to supply power to the mobile phone 17.

In the preferred embodiment, the power supply 19 is functioned to supply power to the mobile phone 17 and is connected to the computer 13 through a GPIB interface.

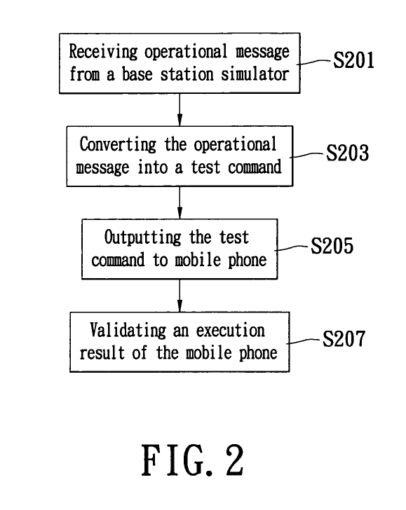

FIG. 2 shows a flowchart for the operation of the automatic testing system according to the present invention. At first, the computer 13 receives an operational message of the base station simulator 11 through a transmission port at step S201. The automatic test program in the computer 13 converts the operational message of the base station simulator 11 into a test command in step S203. The automatic test program in the computer 13 finds a test command stored in a lookup table and associated with the operational message and the computer 13 sends the test command to the mobile phone 17 in step S205. The mobile phone 17 automatically executes the test command and generates a wireless signal transmitted to the base station simulator 11 and the base station simulator 11 validates the execution result in step S207. Therefore, the base station simulator 11 can validate the performance of the mobile phone 17.

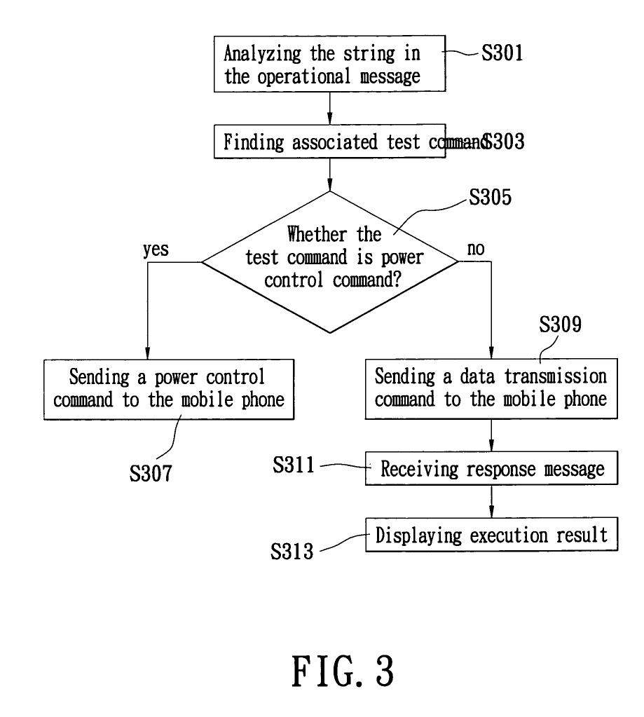

In the step S203 shown in FIG. 2, the automatic test program in the computer 13 performs the following sub-steps shown in FIG. 3 to convert the operational message of the base station simulator 11 into a test command. The automatic test program in the computer 13 first analyzes the string in the operational message of the base station simulator 11 in step S301. The automatic test program then finds an associated test command in the string in step S303. The automatic test program judges whether the test command is a power control command in step S305. If true, the automatic test program sends a power control command to the mobile phone in step S307. If false, the automatic test program sends a data transmission command to the mobile phone in step S309. The computer 13 receives a response message in response to the test command in step S311. The test command in the present invention is an AT command and has a response message in response. The computer 13 displays an execution result according to the response message in step S313.

In step S307, the power control command includes a signal for simulating a power on signal and a power off signal. The power supply 19 will start and stop supplying power to the mobile phone 17 in response to the power on signal and power off signal. Therefore, the mobile phone 17 is commanded to perform power on and power off operation.

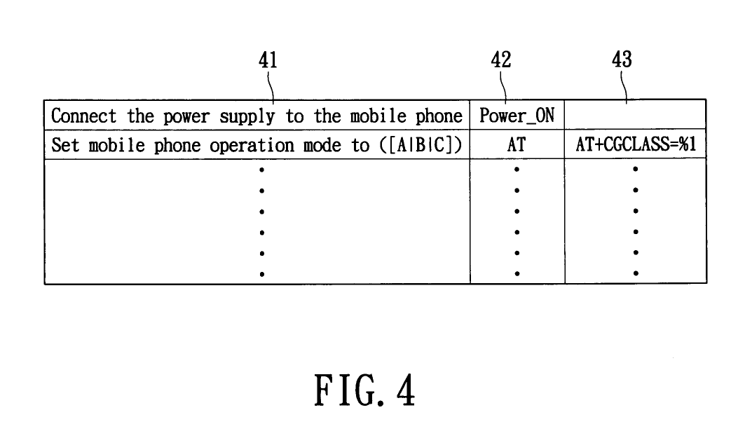

FIG. 4 shows the lookup table according to the present invention. The lookup table includes string field 41, command field 42 and execution field 43. The string field 41 contains a string description associated with specific operation in the operational message and each string field 41 is associated with one command field 42 and one execution field 43. In the step S301, the automatic test program in the computer 13 analyzes the string in the operational message to find a corresponding string in the string field 41 of the lookup table. Once a corresponding string in the string field 41 of the lookup table is found, the command regarding to an associated command field 42 and execution field 43 will be executed.

For example, when the operational message has a string “Connect the power supply to the mobile phone” matched with a preset string in the string field 41, the operational message is referred to as a Power_on command in the command field 42. Therefore, the automatic test program sends a power on simulation signal to the mobile phone 17 and the power supply 19 is commanded to supply power to the mobile phone 17 to turn on the mobile phone 17.

When the operational message has string “Set mobile phone operation mode to ([A|B|C])”, matched with a preset string in the string field 41, the operational message is referred to as an AT command. The automatic test program sends a test command associated with data transmission to the mobile phone 17. The operation of the mobile phone 17 is determined by, for example, the AT+CGCLASS=%1 AT command. However, the actual AT command can be varied according to the specific model of the mobile phone 17.

To sum up, the automatic testing system and method for testing a mobile phone have the following advantages:

1. The test time is saved and test reliability is enhanced by the automatic testing system and method.

2. The automatic testing system and method has better flexibility because it converts the operation message by software. The operation message can be adapted for different test instruments and different types of mobile phones.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. An automatic testing system for a mobile phone, comprising:
a base station simulator providing at least one operational message; and
a test computer connected to the base station simulator through a transmission port and converting the operational message into a test command for outputting to a mobile phone under test;
whereby the mobile phone automatically executes the test command and the base station simulator validates a performance of the mobile phone by examining an execution result of the mobile phone.

2. The automatic testing system as in claim 1, wherein the base station simulator is an Anite testing instrument from Anite Telecom Company or a CRTC testing instrument from R&S Company.

3. The automatic testing system as in claim 1, wherein the transmission port is an RS-232 port.

4. The automatic testing system as in claim 1, wherein the computer comprises a lookup table providing a link between the operational message and the test command.

5. The automatic testing system as in claim 1, wherein the test command is an AT command.

6. The automatic testing system as in claim 1, wherein the mobile phone is connected to the transmission port for receiving the test command.

7. The automatic testing system as in claim 6, wherein the transmission port is an RS-232 port or a USB port.

8. The automatic testing system as in claim 6, further comprising a voltage converter connected between the transmission port and the mobile phone to provide a voltage level conversion between the computer and the mobile phone.

9. The automatic testing system as in claim 8, wherein the voltage converter provides signal transmission between the computer and the mobile phone by connecting associated pins of the computer and the mobile phone.

10. The automatic testing system as in claim 1, further comprising a power supply connected between the computer and the mobile phone for supplying power to the mobile phone.

11. The automatic testing system as in claim 10, wherein the power supply is connected to the computer through a GPIB interface.

12. An automatic testing method for a mobile phone, comprising the steps of:
providing a test computer to test a mobile phone under test;
the test computer converting an operational message from a base station simulator into a test command;
the test computer sending the test command to the mobile phone; and
the base station simulator validating an execution result of the mobile phone.

13. The automatic testing method as in claim 12, wherein the test computer converts the operational message from the base station simulator into the test command according to a lookup table and the lookup table provides a link between the operational message and the test command.

14. The automatic testing method as in claim 12, wherein the test command includes a data transmission command and a power control command.

15. The automatic testing method as in claim 12, wherein the test command is an AT command.

16. The automatic testing method as in claim 12, wherein the base station simulator is an Anite testing instrument from Anite Telecom Company or a CRTC testing instrument from R&S Company.

17. The automatic testing method as in claim 12, further comprising the step of:
providing a voltage converter to provide a voltage level conversion between the computer and the mobile phone.

18. The automatic testing method as in claim 12, further comprising the step of:
the computer controlling a power supply to supply power to the mobile phone.

19. The automatic testing method as in claim 18, wherein the power supply is connected to the computer through a GPIB interface.

20. The automatic testing method as in claim 12, further comprising the step of:
the computer receiving a response message from the mobile phone.

21. The automatic testing method as in claim 20, further comprising the step of:
the computer displaying an execution result according to the response message.

22. The automatic testing method as in claim 12, wherein the base station simulator validates an execution result of the mobile phone by receiving and examining a wireless signal from the mobile phone.
